(19) United States
(12) Patent Application Publication
(10) Pub. No.: US 2024/0076209 A1
(43) Pub. Date: Mar. 7, 2024

(54) ELECTROLYTIC WATER TREATMENT SYSTEM WITH AUTOMATED CATHODE CLEANING MECHANISM THEREOF AND METHOD THEREFOR

(71) Applicant: ECOMAX SOLUTIONS PRIVATE LIMITED, Pune (IN)

(72) Inventor: Mohan Narhari CHAVAN, Pune (IN)

(73) Assignee: ECOMAX SOLUTIONS PRIVATE LIMITED, Pune (IN)

(21) Appl. No.: 18/261,530

(22) PCT Filed: Jan. 15, 2022
(86) PCT No.: PCT/IN2022/050033

§ 371 Date: Jul. 14, 2023

(30) Foreign Application Priority Data
Jan. 15, 2021 (IN) 202121001941

(51) Int. Cl. C02F 1/46

(52) U.S. Cl. CPC C02F 1/46; C02F 2001/46119

(57) ABSTRACT

Disclosed is an electrolytic water treatment system (100) with an automated cathode cleaning mechanism thereof and in a method therefor. The electrolytic water treatment system (100) effectively removes scale forming minerals for large cooling towers and consumes less space. The electrolytic water treatment system (100) utilizes a shell in shell type arrangement so that both sides of anodes (18) and cathodes (16) are used for electrolysis simultaneously which makes the electrolytic water treatment system (100) highly efficient, effective and less expensive. By using the electrolytic water treatment system (100), the life of the anode (18) is increased at least two to three times compared to the polarity reversing method.

### FIELD OF THE INVENTION

The present invention relates to a water treatment system and more particularly, to removal of scale forming minerals from water by way of electrolysis and an automated cleaning mechanism for cleaning the deposited scale on a cathode thereof and a method therefor.

### BACKGROUND OF THE INVENTION

A cooling tower water treatment system is an arrangement to remove damaging impurities from the cooling tower feed water, circulation water, and/or blow down. The circulation water for large cooling towers has higher Total Dissolved Solids and Total Hardness which get deposited into the tubes of heat exchangers causing fouling which in turn results into the process inefficiencies. In order to reduce the non-conductive layer and increase the heat transfer efficiency of the heat exchangers and the entire cooling circuit including the cooling towers; chemicals such as antiscalants, corrosion inhibitors, biocides, etc. are dosed in the cooling tower basin. However, addition of the chemicals to the cooling tower also results into an increase of total dissolved solids (TDS). In order to have effective chemical treatment, the water blow down is given from the cooling tower basin. However, this results into huge quantity of water wastage.

The cooling water treatment system by using electrolysis or electrochemical principle treats the water in electrolytic reactor in the side steam, without disturbing the main cooling water flow. The cooling water from the cooling tower sump is pumped through the electrolytic reactor where the electrolysis takes place. Specifically, the cooling water treatment system by using electrolysis or electrochemical principle is known in the field and available in the market but not widely used by the industries because of the requirement of regular periodic cleaning of the electrodes and not being cost effective.

More specifically, U.S. Pat. Nos. 2,490,730, 2,882,210, 3,378,479, and US Patent applications US20050173242, and US20080093213 discloses system working on the electrochemical principle for treating the cooling water. Further, some of the devices use reverse polarity principle to remove the scale deposited on a negative electrode i.e. cathode periodically followed by a back wash of electrolysis chamber. Some other systems describe cleaning of the negative electrode by using the scraping mechanism which uses a motor and the drive mechanism to drive the scrapper which in turn will remove the scale deposited on the negative electrode. The present system resulting in problems such as
1. Periodic manual cleaning of negative electrode i.e., cathode is required which is labour intensive and cumbersome. Further, the system for the treatment needs to be stopped for cleaning. If the periodic cleaning is not done effectively, it affects the life of the positive electrode i.e. anode and necessitates the replacement of costly electrode adding to the increase of operating cost.
2. Periodic reversal of polarity to the electrodes reduces the life of the expensive positive electrode i.e. anode and adds to increasing operational costs.
3. Small scale self-cleaning reactors use one side of anode and cathode for electrolysis, thus the area required to install such small reactors for large cooling towers would be huge and hence the deployment of electrolytic treatment system for a large cooling tower poses a problem.
4. The scrapper mechanism used for cleaning the negative electrode online involves moving parts such as motor drive mechanism, mechanical scrapper which in turn will remove the scale deposited on the negative electrode. If these small self-cleaning reactors are to be deployed for large cooling towers, the foot print required is huge and also would pose challenges with respect to maintenance, thus there is a limitation.

Accordingly, there is a need for a system for removing scale-forming minerals from the water by using electrolysis principle with an automated in-situ cleaning mechanism for large capacity cooling towers, which overcomes the above mentioned drawbacks of the prior art.

### OBJECTS OF THE INVENTION

An object of the present invention is to provide an effective treatment of cooling tower circulation water by way of electrolysis for large capacity cooling towers.

Another object of the present invention is to automatically remove the deposited minerals on the walls of the cathode.

Another object of the present invention is to save the water that is wasted in the cooling tower blow down.

Another object of the present invention is to minimize/eliminate use of chemicals treatment for the cooling tower system.

Another object of the present invention is to minimize footprint/space required and yet give effective results.

Yet another object of the present invention is to avoid reversing polarity of the electrodes i.e. anode and cathode of the electrolytic water treatment system for cooling towers.

### SUMMARY OF THE INVENTION

Accordingly, the present invention provides an electrolytic water treatment system (hereinafter, “the system”) with automated cathode cleaning mechanism thereof. The system comprises an electrolytic reactor, a scrapper mechanism, a gear mechanism, a water circulating pump, a controller, a pH meter, a total dissolved solids (TDS) meter and a direct current (DC) power source.

The electrolytic reactor includes a housing, a plurality of cathodes and a plurality of anodes. The housing includes at least one gas vent configured on a housing plate positioned on a top portion thereof, and a detachable bottom portion. The plurality of cathodes is placed in shell in shell type arrangement at an inner side of the housing and attached to the bottom portion with the help of a support. Specifically, the plurality of cathodes is cylindrical in shape and made up of stainless steel. The plurality of anodes is arranged in a circular fashion between two shells of the cathode and attached to the bottom portion with the help of a plurality of bottom rings and supported by a ring at a top portion of anodes. Specifically, the plurality of anodes is arc shaped mesh type anodes made of titanium and has a coating of oxides of precious metal like iridium, ruthenium and titanium thereon. The scrapper mechanism removes the scales deposited on the plurality of cathodes. The scrapper mechanism includes a plurality of triangular shape scrapper blades, a scrapper top gear plate, a scrapper top ring and a plurality of scrapper bottom rings. The plurality of triangular shape scrapper blades is placed in a gap between the two cathodes shells thereby making a contact with an inner surface of one shell and an outer surface of another shell. The plurality of triangular shape scrapper blades is attached with the gear mechanism by means of the scrapper top gear plate, the scrapper top ring and the plurality of scrapper bottom rings. The scrapper top gear plate includes holes configured thereon for release of gas produced during an electrolysis process. The scrapper top gear plate has a male guide on the top of which moves in a female guide mounted on the housing plate of the electrolytic rector.

The gear mechanism includes at least one gear motor and a gear pinion. The gear motor is attached with the scrapper mechanism by means of the scrapper top gear plate. The gear pinion is placed nearly at a center of the inner cathode shell and attached to the gear motor to rotate a movable gear train with the scrapper mechanism. The water circulation pump pumps water to the electrolytic reactor, wherein water flow passes through an annular space between the shells of the cathodes. The pH meter and the TDS meter are provided at an outlet of the electrolytic reactor. The DC power source is mounted on a skid for supplying direct current to the electrolytic reactor for conducting the electrolysis process therein. The control panel is mounted on the skid for controlling the operations of the electrolytic reactor, the water circulation pump, the pH meter and the TDS meter.

In accordance with the present invention, rotation of the gear pinion causes rotation of the top gear plate in a clockwise direction or an anticlockwise direction depending on motor rotation that in turn causes rotation of the scrapper arrangement thereby scraping off of the scale deposited on an internal surface of one shell and an external surface of another adjacent shell of the cathode thereby ensuring periodic cleaning of the cathode shells resulting in efficient electrolysis.

In another aspect, the present invention provides a method for electrolytic water treatment system with automated cathode cleaning mechanism.

### BRIEF DESCRIPTION OF THE DRAWINGS

The objects and advantages of the present invention will become apparent when the disclosure is read in conjunction with the following figures, wherein FIG. 1 is an assembly drawing of a skid mounted electrolytic water treatment system, in accordance with the present invention;

FIGS. 2-3 show a schematic drawing of an electrolytic reactor, in accordance with the present invention;

FIG. 4 show a schematic drawing of an assembly inside the electrolytic reactor, in accordance with the present invention;

FIG. 5 shows a shell in shell cathode arrangement, in accordance with the present invention;

FIG. 6 shows a schematic drawing of an anode arrangement, in accordance with the present invention;

FIG. 7 shows the cathode arrangement with a scrapper mechanism, in accordance with the present invention; and

FIG. 8 shows a schematic drawing of the scrapper mechanism arrangement in the electrolytic reactor, in accordance with the present invention.

### DETAILED DESCRIPTION OF THE INVENTION

The foregoing objects of the present invention are accomplished and the problems and shortcomings associated with the prior art, techniques and approaches are overcome by the present invention as described below in the preferred embodiment.

The present invention provides an electrolytic water treatment system for removing scale-forming minerals from water by using electrolysis principle in the heat exchanger system such as cooling towers of the industrial process. The system provides a self-cleaning mechanism to remove the deposited minerals on the walls of the cathode.

The present invention is illustrated with reference to the accompanying drawings, throughout which reference numbers indicate the corresponding parts in the various figures. These reference numbers are shown in the bracket in the following description.

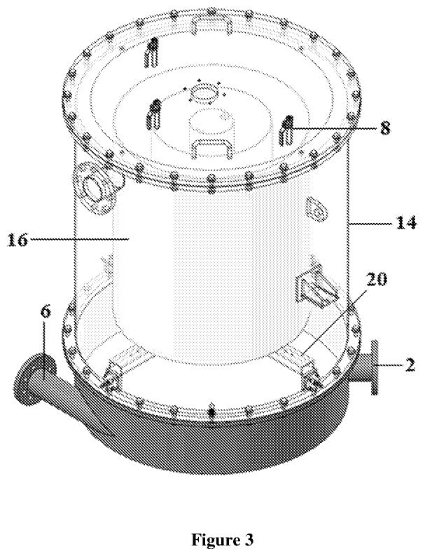

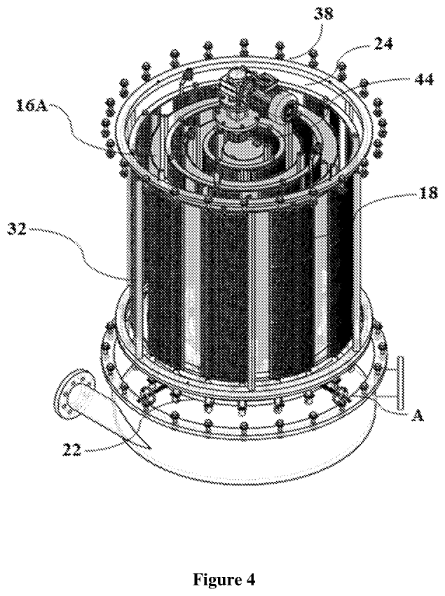

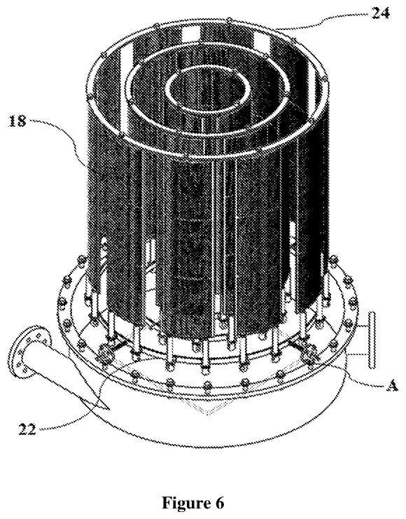

Referring to FIGS. 1 to 8, an electrolytic water treatment system (100) (hereinafter ‘the system (100)’) for removing scale forming minerals from the water using an electrolysis principle in a heat exchanger system of the industrial process, in accordance with the present invention is shown. As shown in FIG. 1, the system (100) comprises an electrolytic reactor (30), a scrapper mechanism (not numbered), a gear mechanism (not numbered), a water circulation pump (46), a pH meter/sensor (48), a total dissolved solids meter/sensor (hereinafter, “TDS meter (50)”), a control panel/controller (52) and a direct current (DC) power source (54).

The electrolytic reactor (30) is placed at the upstream of the water circulation pump (46). A flow switch (26) is placed between a pump discharge and an inlet (2) on the electrolytic reactor (30). The pH meter (48) and the TDS meter (50) along with one control valve (28) and a manual valve (not numbered) are provided at an outlet (4) of the electrolytic reactor (30). One control valve (not numbered) and a manual valve (not numbered) are provided at a drain pipe (6) located at the bottom of the electrolytic reactor (30).

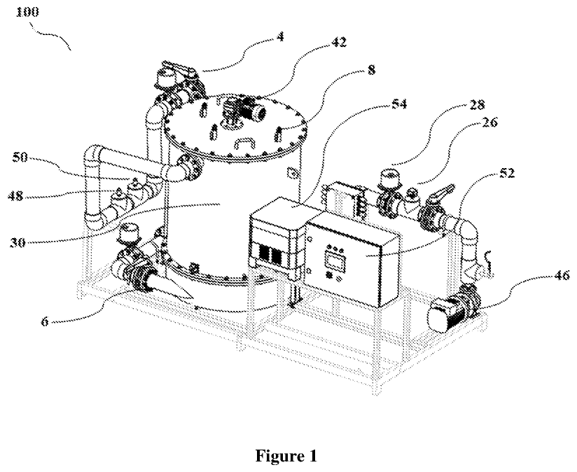

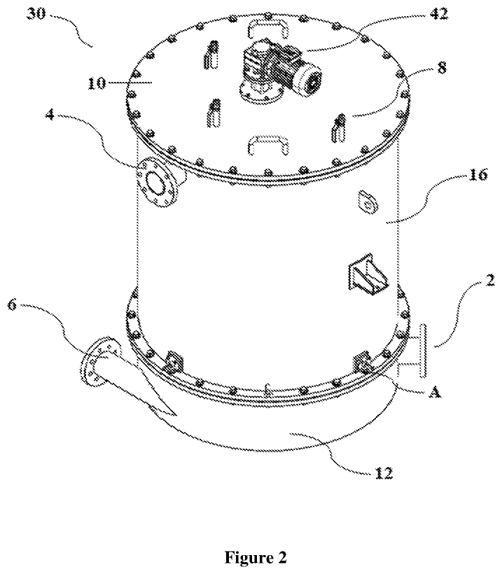

As shown in FIG. 2, the electrolytic reactor (30) includes a housing (14), a plurality of cathodes (16) (hereinafter, “cathodes (16)”) and a plurality of anodes (18) (hereinafter, “anodes (18)”). The housing (14) is a metallic enclosure which is divided into two parts namely a top portion (not numbered) and a bottom portion (12). The top portion includes a housing plate (10) positioned thereon. The housing plate (10) includes at least one gas vent (8) configured thereon. The top portion is an active portion where electrolysis takes place. The bottom portion (12) is a passive portion for providing support for the cathodes (16) and the anodes (18). The bottom portion (12) collects the scale removed from the cathodes (16). The bottom portion (12) is easily detachable from the housing (14) for cleaning and maintenance purpose.

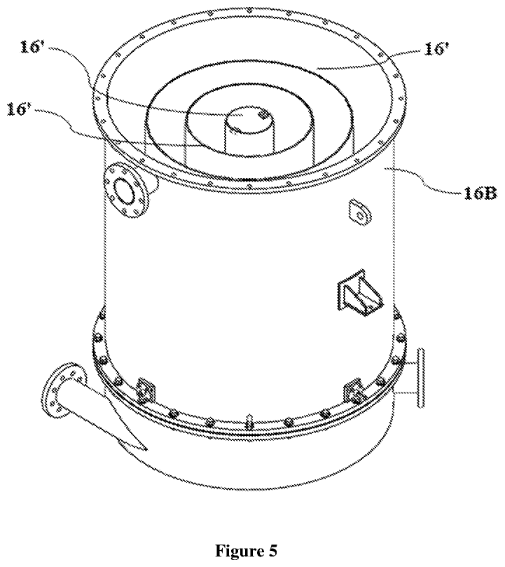

The cathodes (16) are attached to the bottom portion (12) with the help of a support (20). The cathodes (16) are cylindrical in shape and placed in shell in shell type arrangement at an inner side of the housing (14). In an exemplary embodiment, the shell in shell cathode arrangement having a first cathode shell (16′), a second cathode shell (16′) and a third cathode shell (16′) is shown in FIG. 5. This arrangement ensures that the entire cathode area is covered during the cleaning of an inner shell (16A) and an outer shell surface (16B) of the cathodes (16) with the help of the scrapper mechanism. Specifically, the cathodes (16) are made up of stainless steel and the like material. However, it is understood here that the number of shells of the cathodes (16) shown figures are to be interpreted merely as an illustration and they are in no way to be construed as a limitation.

The anodes (18) are arranged in a circular fashion between the two shells (16′) of the cathode (16) and are attached to the bottom portion (12) with the help of a plurality of bottom rings (22) and supported by a ring (24) at the top portion of the anodes (18). The connection of the anodes (18) to the bottom portion (12) is denoted by “A” in figures. The anodes (18) are arc shaped mesh type anodes. The anodes (18) are made up of titanium metal and the like material. In an embodiment, the arc shaped mesh type anodes (18) have a coating of oxides of other precious metal like iridium, ruthenium and titanium thereon.

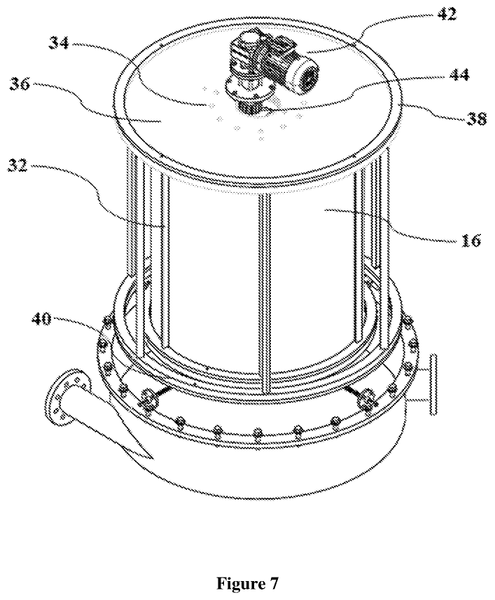

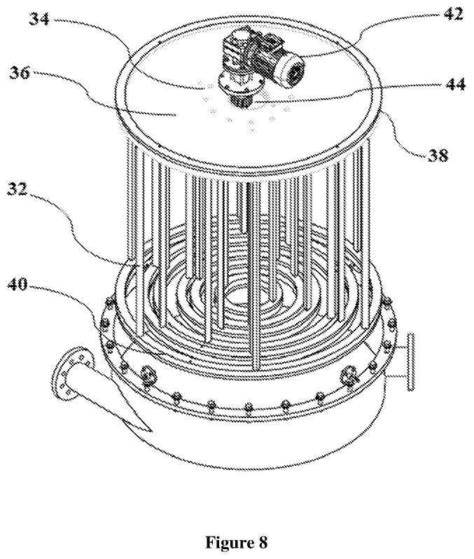

The scrapper mechanism removes the scales deposited on the cathodes (16) with the help of the gear mechanism. As shown in FIGS. 7-8, the scrapper mechanism includes a plurality of triangular shape scrapper blades (32) (hereinafter, “scrapper blades (32)”), at least one scrapper top gear plate (36), at least one scrapper top ring (38) and a plurality of scrapper bottom rings (40). The scrapper blades (32) are placed in a gap between the two cathodes shells (16′) such that they make a contact with the inner surface (16A) of one shell (16′) and the outer surface (16B) of another shell (16′). The scrapper blades (32) are attached with the gear mechanism by means of the scrapper top gear plate (36), the scrapper top ring (38) and the plurality of scrapper bottom rings (40). The scrapper top gear plate (36) includes holes (34) configured thereon for release of gas produced during electrolysis process where the scrapper blades (32) are fixed. The scrapper top gear plate (36) has a male guide (not shown) on the top of which moves in a female guide mounted on the housing plate (10) of the electrolytic rector (30).

As shown in FIGS. 7-8, the gear mechanism includes at least one gear motor (42) and a gear pinion (44). The gear motor (42) is attached with the scrapper mechanism by means of the scrapper top gear plate (36). The gear pinion (44) is attached to the gear motor (42) to rotate a movable gear train with the scrapper mechanism. The gear pinion (44) is placed nearly at the center of the inner cathode shell. The rotation of the gear pinion (44) causes rotation of the top gear plate in a clockwise direction or anticlockwise direction depending on the direction of motor rotation that in turn causes rotation of the scrapper arrangement that causes scraping off of the scale deposited on the surfaces including an internal and external surface of the cathode shells. This arrangement ensures periodic cleaning of the cathode shells, so that the electrolysis happens efficiently.

The control panel (52) and the DC power source (54) are placed on the skid near the electrolytic reactor (30) as shown in FIG. 1. The water circulation pump (46) takes small quantity of water, less than 5% of the circulation water flow rate from a cooling tower basin and pumps the water to the electrolytic reactor (30) where electrolysis takes place. The DC power source (54) mounted on the skid supplies DC current to the electrolytic reactor (30) for conducting the electrolysis process therein. The pH meter (48) and the TDS meter (50) sense the parameters and display on a control panel HMI for the purpose of monitoring and control. The TDS meter (50) is used to control the blowdown, the control value is set on the HMI for TDS and once the set value is reached blowdown cycle is initiated by the control panel (52) automatically by opening a drain control valve mounted in the bottom drain pipe (6). The automated scrapping mechanism is used to scrap the scale deposited on the cathode walls, the scrapping takes place periodically at the pre-set time intervals. The controller/control panel (52) mounted on the skid controls all the operations automatically.

In accordance with the present invention, the water circulation pump (46) facilitates the flow of water into the electrolytic reactor (30) from the inlet (2) to the outlet (4). The water flow passes through the annular space between the shells (16′) of the cathodes (16). As the water passes from the bottom to the top of the cathodes (16), the DC power source provides the DC current to the electrodes, thus the electrochemical reactions start at the anodes (18) and the cathodes (16). This arrangement provides more contact area of the water to be treated with the anodes (18) and the cathodes (16). Further, this arrangement offers more residence time resulting in an effective electrochemical reaction.

When the DC current is passed through the anodes (18) and the cathodes (16), a plurality of OH— ions are generated at the cathodes (16) which creates high pH environment at the walls thereof. This results in the precipitation of calcium, magnesium and other salts present in the water into the electrolytic reactor (30). Further, the chlorine gas is generated at anode (18) which acts as the biocide and avoids or reduces bacterial growth in the cooling tower water.

The reactions during electrolysis are given below:
1. Primary Anode Reaction (Oxidation of Water)

2H₂O-4e⁻¹=>O₂+4H⁺1
2. Primary Cathode Reaction (Reduction of Water)

4H₂O+4e⁻¹=>H_{2(g)}+4OH⁻
3. Secondary Cathode Reactions:

Ca²⁺+HCO⁻₃+OH⁻=>CaCO_{3(Pre)}+H₂O

Mg²⁺+2OH⁻=>Mg(OH)₂₍ₚᵣₑ₎
4. Secondary Anode reactions:

2Cl⁻=>Cl_{2(g)}+2e⁻

In another aspect, the present invention provides a method for electrolytic water treatment system with automated cathode cleaning mechanism. The method is described hereinafter in conjunction with the system (100). In a first step, the method involves providing the electrolytic reactor (30). Thereafter, the plurality of cathodes (16) are placed in shell in shell type arrangement at the inner side of the housing (14) of the electrolytic reactor (30). The plurality of anodes (18) is then arranged in a circular fashion between two shells (16′) of the cathode (16). The scales deposited on the plurality of cathodes (16) are then removed by the scrapper mechanism. The water circulation pump (46) pumps the water to the electrolytic reactor (30), wherein water flow passes through an annular space between the shells (16′) of the cathodes (16). The controlling and the operation of the electrolytic reactor (30) and the water circulation pump (46) are performed by a control panel (52).

### Advantages of the Invention

1. The system (100) effectively removes scale forming minerals for large cooling towers and consumes less space.
2. The system (100) utilizes a shell in shell type arrangement so that both sides of the anodes (18) and the cathodes (16) are used for electrolysis simultaneously with more anode to cathode area ratio which makes the system (100) highly efficient, effective and less expensive.
3. The anodes (18) of the system (100) have same dimensions, thus replacement becomes easy being a modular design without the need to change all the electrodes in case of failure of one or more electrodes.
4. The present invention provides online cleaning of the shell in shell type cathode's surfaces thereby avoiding the need to stop the system (100) for cleaning.
5. The system (100) provides improved effectiveness of removing scale-forming minerals.
6. By using the system (100), the life of the anode (18) is increased at least two to three times compared to the polarity reversing method.
7. The system (100) is very cost effective, compact and reduces operational and maintenance cost.

The foregoing objects of the invention are accomplished and the problems and shortcomings associated with prior art techniques and approaches are overcome by the present invention described in the present embodiment. Detailed descriptions of the preferred embodiment are provided herein; however, it is to be understood that the present invention may be embodied in various forms.

Therefore, specific details disclosed herein are not to be interpreted as limiting, but rather as a basis for the claims and as a representative basis for teaching one skilled in the art to employ the present invention in virtually any appropriately detailed system, structure, or matter. The embodiments of the invention as described above and the methods disclosed herein will suggest further modification and alterations to those skilled in the art. Such further modifications and alterations may be made without departing from the scope of the invention.

We claim:

1. An electrolytic water treatment system (100) with automated cathode cleaning mechanism thereof, the electrolytic water treatment system (100) comprising:
an electrolytic reactor (30) having,
a housing (14) having at least one gas vent (8) configured on a housing plate (10) positioned on a top portion thereof, and a detachable bottom portion (12),
a plurality of cathodes (16) placed in shell in shell type arrangement at an inner side of the housing (14) and attached to the bottom portion (12) with the help of a support (20), and
a plurality of anodes (18) arranged in a circular fashion between two shells (16′) of the cathode (16) and attached to the bottom portion (12) with the help of a plurality of bottom rings (22) and supported by a ring (24) at a top portion of anodes (18);
a scrapper mechanism for removing the scales deposited on the plurality of cathodes (16), the scrapper mechanism having,
a plurality of triangular shape scrapper blades (32) placed in a gap between the two cathodes shells (16′) thereby making a contact with an inner surface (16A) of one shell (16′) and an outer surface (16B) of another shell (16′), and
a scrapper top gear plate (36) having holes (34) configured thereon for release of gas produced during an electrolysis process;
a gear mechanism having,
at least one gear motor (42) attached with the scrapper mechanism by means of the scrapper top gear plate (36), and
a gear pinion (44) placed nearly at the center of the inner cathode shell and attached to the gear motor (30) to rotate a movable gear train with the scrapper mechanism;
a water circulation pump (46) for pumping water to the electrolytic reactor (30), wherein water flow passes through an annular space between the shells (16′) of the cathodes (16),
an optional pH meter (48) and a total dissolved solids meter (50) provided at an outlet (4) of the electrolytic reactor (30);
a direct current power source (54) mounted on a skid for supplying direct current to the electrolytic reactor (30) for conducting the electrolysis process therein;
a control panel (52) mounted on the skid for controlling the operations of the electrolytic reactor (30), the water circulation pump (46), the pH meter (48) and the total dissolved solids meter (50),
wherein, rotation of the gear pinion (44) causes rotation of the top gear plate in a clockwise direction or an anticlockwise direction depending on motor rotation that in turn causes rotation of the scrapper arrangement thereby scraping off of the scale deposited on an internal surface (16A) of one shell (16′) and an external surface (16B) of another adjacent shell (16′) of the cathode (16) thereby ensuring periodic cleaning of the cathode shells (16′).

2. The electrolytic water treatment system (100) as claimed in claim 1, wherein the plurality of cathodes (16) is cylindrical in shape and made up of stainless steel.

3. The electrolytic water treatment system (100) as claimed in claim 1, wherein the plurality of anodes (18) is arc shaped mesh type anodes made of titanium metal and has a coating of oxides of precious metal like iridium, ruthenium and titanium thereon.

4. The electrolytic water treatment system (100) as claimed in claim 1, wherein the plurality of triangular shape scrapper blades (32) is attached with the gear mechanism by means of the scrapper top gear plate (36), a scrapper top ring (38) and a plurality of scrapper bottom rings (40).

5. The electrolytic water treatment system (100) as claimed in claim 1, wherein the scrapper top gear plate (36) has a male guide on the top of which moves in a female guide mounted on the housing plate (10) of the electrolytic rector (30).

6. A method for electrolytic water treatment system with automated cathode cleaning mechanism, the method comprising the steps of:
providing an electrolytic reactor (30);
placing a plurality of cathodes (16) in shell in shell type arrangement at an inner side of a housing (14) of the electrolytic reactor (30);
arranging a plurality of anodes (18) in a circular fashion between two shells (16′) of the cathode (16);
removing scales deposited on the plurality of cathodes (16) by a scrapper mechanism; and
pumping water using a water circulation pump (46) to the electrolytic reactor (30), wherein water flow passes through an annular space between the shells (16′) of the cathodes (16).

7. The method as claimed in claim 6, wherein controlling and the operation of the electrolytic reactor (30) and the water circulation pump (46) are performed by a control panel (52).

8. The method as claimed in claim 6, wherein the plurality of cathodes (16) is cylindrical in shape and made up of stainless steel.

9. The method as claimed in claim 6, wherein the plurality of anodes (18) is arc shaped mesh type anodes made of titanium and has a coating of oxides of precious metal like iridium, ruthenium and titanium thereon.
